(19) United States
(12) Patent Application Publication
(10) Pub. No.: US 2022/0198577 A1
(43) Pub. Date: Jun. 23, 2022

(54) INFORMATION PROCESSING APPARATUS, INFORMATION PROCESSING METHOD, AND NON-TRANSITORY COMPUTER READABLE MEDIUM

(71) Applicant: FUJIFILM Business Innovation Corp., Tokyo (JP)

(72) Inventors: Daisuke TATSUMI, Kanagawa (JP); Manabu UEDA, Kanagawa (JP); Akane ABE, Kanagawa (JP); Jun ANDO, Kanagawa (JP)

(73) Assignee: FUJIFILM Business Innovation Corp., Tokyo (JP)

(21) Appl. No.: 17/321,526

(22) Filed: May 17, 2021

(30) Foreign Application Priority Data
Dec. 23, 2020 (JP) 2020-214206

(51) Int. Cl. G06Q 40/00; G06N 5/02

(52) U.S. Cl. CPC G06Q 40/12; G06N 5/02

(57) ABSTRACT

An information processing apparatus includes a processor configured to present an account title relating to information obtained from a voucher together with related information relating to the account title.

### CROSS-REFERENCE TO RELATED APPLICATIONS

This application is based on and claims priority under 35 USC 119 from Japanese Patent Application No. 2020-214206 filed Dec. 23, 2020.

### BACKGROUND

### (i) Technical Field

The present disclosure relates to an information processing apparatus, an information processing method, and a non-transitory computer readable medium.

### (ii) Related Art

Japanese Patent No. 6342583 discloses a technique relating to an accounting process apparatus that automatically makes a journal entry to an account title corresponding to a content of a transaction. The accounting process apparatus includes: an automatic journal entry unit that has learned using machine learning to output account title candidates corresponding to a content of a transaction and reliability of the respective account title candidates as a journal entry result; a journal entry data generation unit that generates journal entry data including account title candidates corresponding to the content of a transaction and reliability of the respective account title candidates based on the journal entry result output from the automatic journal entry unit; and a journal entry presentation unit that presents to a user the account title candidates and the reliability of the respective account title candidates based on the journal entry data generated by the journal entry data generation unit in such a way that one of the account title candidates is selectable. The journal entry data generation unit generates the journal entry data by determining, of the journal entry result output from the automatic journal entry unit, an account title candidate that is a bookkeeping error for the content of the transaction and by attaching additional information representing that this account title candidate is a booking error, and the journal entry presentation unit presents to a user the account title candidate that is a bookkeeping error based on the additional information using a representation different from a representation of the other account title candidates.

### SUMMARY

There are information processing apparatuses that manage electronic ledgers, financial statements, and the like. Such an information processing apparatus sometimes includes, for example, a function that makes an estimate of the account title in the accounting relating to a voucher and presents estimated account titles when the voucher relating to a transaction is input. When only the account titles are presented, there is no information for assessing the presented account titles.

Aspects of non-limiting embodiments of the present disclosure relate to an information processing apparatus and an information processing method, each of which presents information for assessing the account titles, and further relates to a non-transitory computer readable medium storing a program therefor. Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to present an account title relating to information obtained from a voucher together with related information relating to the account title.

### BRIEF DESCRIPTION OF THE DRAWINGS

An exemplary embodiment of the present disclosure will be described in detail based on the following figures, wherein:

FIG. 1 is a block diagram illustrating an example of hardware configuration of an information processing apparatus according to the present exemplary embodiment;

FIG. 2 is a block diagram illustrating an example of functional configuration of the information processing apparatus according to the present exemplary embodiment;

FIG. 3 is a schematic diagram illustrating an example of data structure relating to account titles according to the present exemplary embodiment;

FIG. 4 is a schematic diagram illustrating an example of data structure relating to conditions according to the present exemplary embodiment;

FIG. 5 is a front view illustrating an example of an account title display screen according to the present exemplary embodiment;

FIG. 6 is a front view illustrating an example of a history display screen according to the present exemplary embodiment;

FIG. 7 is a front view illustrating an example of a reference material display screen according to the present exemplary embodiment;

FIG. 8 is a flowchart illustrating an example of a process flow for presenting account titles and related information according to the present exemplary embodiment; and

FIG. 9 is a flowchart illustrating an example of a process flow for generating a presentation sentence relating to conditions of an account title according to the present exemplary embodiment.

### DETAILED DESCRIPTION

Hereinafter, an exemplary embodiment for implementing the present disclosure are described in detail with reference to the drawings.

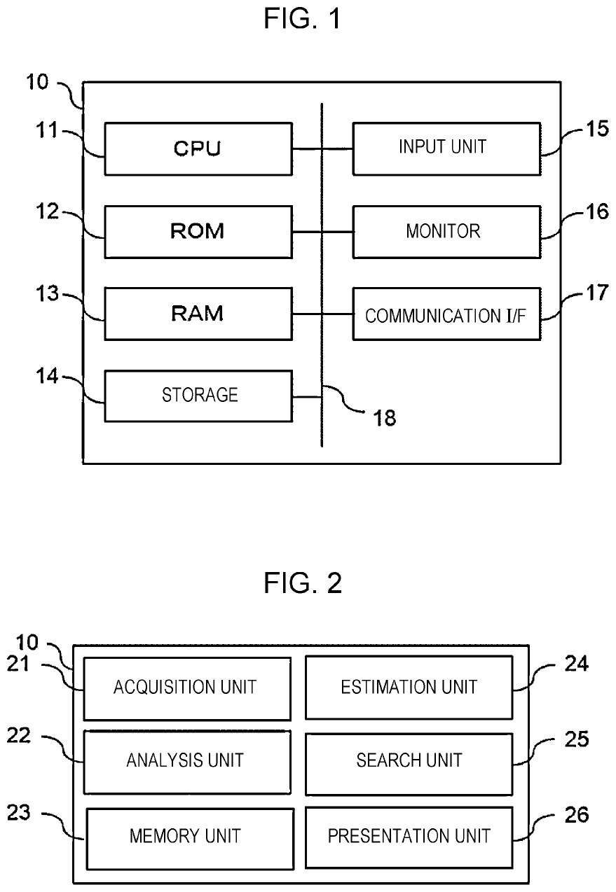

Referring to FIG. 1, the configuration of an information processing apparatus 10 is described. FIG. 1 is a block diagram illustrating an example of the hardware configuration of the information processing apparatus 10 according to the present exemplary embodiment. As an example, an embodiment is described in which the information processing apparatus 10 is used as a terminal such as a personal computer or the like or used as a server.

As illustrated in FIG. 1, the information processing apparatus 10 according to the present exemplary embodiment is configured to include a central processing unit (CPU) 11, a read only memory (ROM) 12, a random access memory (RAM) 13, a storage 14, an input unit 15, a monitor 16, and a communication interface (communication I/F) 17. The CPU 11, the ROM 12, the RAM 13, the storage 14, the input unit 15, the monitor 16, and the communication I/F 17 are connected to each other via a bus 18. Here, the CPU 11 is an example of the processor.

The CPU 11 controls the entirety of the information processing apparatus 10. The ROM 12 stores therein various programs including an information processing program to be used in the present exemplary embodiment, data, and the like. The RAM 13 is a memory to be used as a work area at the time of executing various programs. The CPU 11 performs a process to display one or more account titles and information relating to the one or more account titles (hereinafter, referred to as “related information”) by loading one or more programs stored in the ROM 12 into the RAM 13 and executing the one or more programs. The storage 14 is, for example, a hard disk drive (HDD), a solid state drive (SSD), a flash memory, or the like. Note that the storage 14 may store the information processing program and the like. The input unit 15 is a mouse, a keyboard, and the like for receiving input of characters. The monitor 16 displays one or more account titles and related information. The communication I/F 17 transmits and receives data.

Next, referring to FIG. 2, the functional configuration of the information processing apparatus 10 is described. FIG. 2 is a block diagram illustrating an example of the functional configuration of the information processing apparatus 10 according to the present exemplary embodiment.

As illustrated in FIG. 2, the information processing apparatus 10 includes an acquisition unit 21, an analysis unit 22, a memory unit 23, an estimation unit 24, a search unit 25, and a presentation unit 26. By executing the information processing program, the CPU 11 functions as the acquisition unit 21, the analysis unit 22, the memory unit 23, the estimation unit 24, the search unit 25, and the presentation unit 26.

The acquisition unit 21 obtains image data generated by reading a document that serves as a voucher of a transaction in an accounting process or the like. Here, the document that serves as a voucher is a document such as an invoice, a receipt, a business form, or the like, which indicates that a transaction has been conducted. Note that the present exemplary embodiment is described using the embodiment in which the image data is obtained. However, the exemplary embodiment is not limited thereto. Alternatively, information relating to a transaction input by a user, information relating to a user stored in the memory unit 23 which will be described below, image data obtained in the past, past information relating to the identical transaction, and the like may be obtained.

The analysis unit 22 obtains information included in the image data (document) by applying an optical character recognition (OCR) process to the obtained image data and extracts a string of characters therefrom. Here, the information included in the image data (document) is, for example, the date of a transaction, an amount, the name of a product to be described in the description, the name of a client, the name of an organization conducting the transaction, the name of a person in charge of the transaction, the organization to which the person in charge of the transaction belongs, and the like. Note that the analysis unit 22 according to the present exemplary embodiment is described using the embodiment in which the information is extracted from the image data in the form of a string of characters. However, the exemplary embodiment is not limited thereto. Alternatively, the type of the document in the image data may be identified by using the extracted information. For example, a document may be identified by extracting a string of characters located at a predetermined position such as a title or the like written on the document, or a document may be discerned by extracting an identifier or the like for discerning the document, or a document may be discerned from the position of a string of characters, a ruled line, or the like included in the document. Note that in the following part, image data pertaining to a transaction input by a user, information relating to a transaction input by a user, and information extracted from the image data by the analysis unit 22 are referred to as “transaction information”.

The memory unit 23 stores therein past image data, past transaction information, account titles pertaining to the past transaction information, reference materials relating to the account titles such as accounting rules, laws and regulations relating to accounting, management indicators, or the like (hereinafter, referred to as “reference material”).

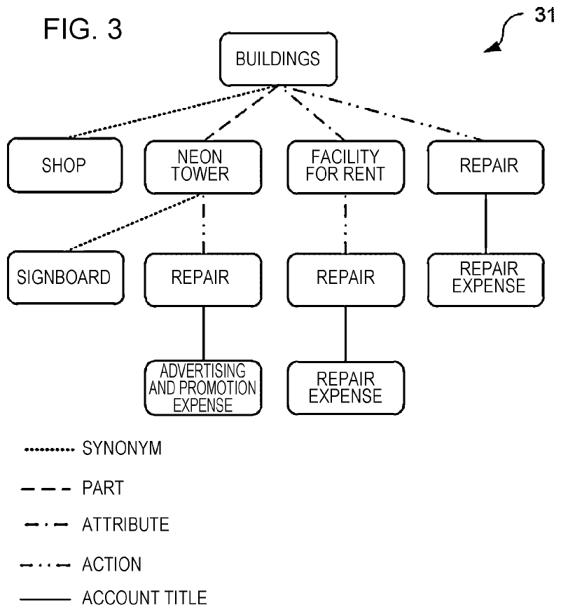

As the past transaction information, the memory unit 23 stores image data input in the past, the transaction information pertaining to the image data input in the past, and the account titles pertaining to past transactions in connection with each other. Specifically, the memory unit 23 stores, for example, a data structure 31 relating to account titles illustrated in FIG. 3. The data structure is a structure that stores arbitrary information pertaining to a past transaction in connection with other information. For example, in the data structure 31 relating to account titles illustrated in FIG. 3, with regard to “buildings”, pieces of information are stored in connection with each other in accordance with rules such as “shop” being represented as the synonym, “neon tower” being represented as the part of buildings, “facility for rent” being represented as the attribute, “repair” being represented as the action for buildings, and the like. Furthermore, in the data structure 31 relating to account titles, “repair expense” and “advertising and promotion expense”, each of which represents the account title, are stored in connection with the “repair” which is information representing the action for buildings. For example, even when the words “buildings” and “repair” are obtained from the transaction information, in the case where the word “neon tower” is linked with the words “buildings” and “repair” because of a past transaction, the account title “advertising and promotion expense” can be estimated by reference to the data structure relating to account titles.

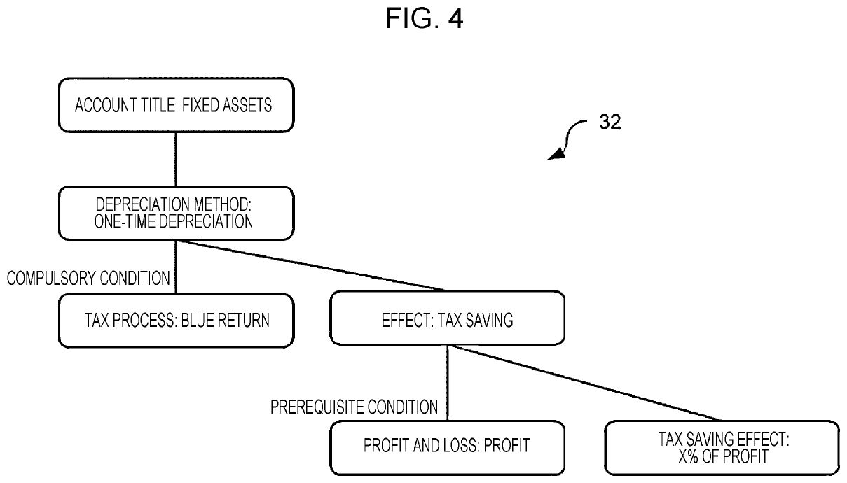

Furthermore, the memory unit 23 stores, for example, a data structure 32 relating to conditions illustrated in FIG. 4. In the data structure 32 relating to conditions, an account title is linked with information relating to conditions for account title selection. For example, as illustrated in FIG. 4, information of the account title “fixed assets” is linked with information when the depreciation method “one-time depreciation” is used. In the data structure 32 relating to conditions, the depreciation method “one-time depreciation” is linked with information that the effect “tax saving” can be achieved when the tax process “blue return”, which is a compulsory condition, is satisfied. Furthermore, in the data structure 32 relating to conditions, the information of the effect “tax saving” is linked with information of the tax saving effect “X % of profit” when the profit and loss “profit”, which is a prerequisite condition, is satisfied. Here, the data structure 31 relating to account titles and the data structure 32 relating to conditions are examples of a knowledge structure.

Using input image data and transaction information pertaining to the image data, the estimation unit 24 makes an estimate of the account title pertaining to the transaction information and the value representing the accuracy of an estimated account title (hereinbelow, referred to as “reliability”).

Specifically, the estimation unit 24 is a neural network that has learned in order to make an estimate of the account title pertaining to a transaction using image data of past transactions and past transaction information as input data and using account titles pertaining to the past transactions as training data. For example, the estimation unit 24 makes an estimate of the account title pertaining to the transaction information and the reliability thereof by identifying similar transaction information in the past using the date, the amount, the name of a product to be described in the description, the name of a client, the name of an organization conducting the transaction, or the like of the transaction included in the transaction information. Furthermore, the estimation unit 24 searches the memory unit 23 for image data similar to the obtained image data, identifies past similar transaction information, and makes an estimate of the account title pertaining to the transaction information and the reliability thereof. Furthermore, the estimation unit 24 makes an estimate of the account title pertaining to the transaction information and the reliability thereof using the data structure 31 relating to account titles stored in the memory unit 23.

The search unit 25 searches the memory unit 23 for related information relating to an account title estimated by the estimation unit 24. Specifically, the search unit 25 obtains, as the related information, past transaction information stored in the memory unit 23 using pieces of information linked with each other in the data structure 31 relating to account titles. Furthermore, the search unit 25 obtains, as the related information, the reference material and the past transaction information stored in the memory unit 23 using transaction information and the estimated account title. Furthermore, the search unit 25 searches for image data similar to the obtained image data and obtains, as the related information, past transaction information pertaining to the similar image data.

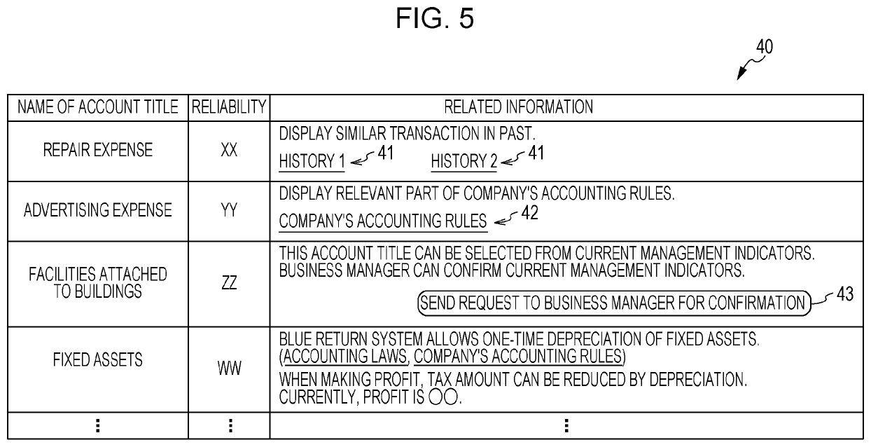

The presentation unit 26 presents one or more account titles and reliability thereof estimated by the estimation unit 24 and related information retrieved by the search unit 25. As an example, as illustrated in FIG. 5, the presentation unit 26 displays an account title display screen 40. The account title display screen 40 includes account titles, reliability, and related information. Here, the account title is the name of an account title, the reliability is a degree of accuracy of the account title, and the related information is information relating to the account title.

The presentation unit 26 displays related information retrieved by the search unit 25 at the related information of the account title display screen 40. As an example, as illustrated in FIG. 5, the presentation unit 26 presents past transaction information and reference materials as the related information that serve as a basis for the presented account titles. For example, the presentation unit 26 displays a link 41 pertaining to past transaction information at the related information of the account title display screen 40 and presents the past transaction information pertaining to the account title when the link 41 pertaining to the past transaction information is pressed down.

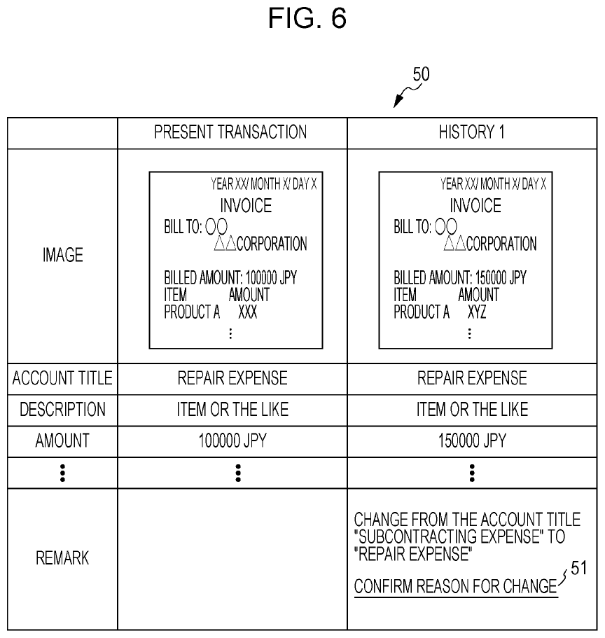

When the pressing down of the link 41 pertaining to the past transaction information is detected, the presentation unit 26 displays a history display screen 50 illustrated in FIG. 6. The history display screen 50 displays images, account titles, descriptions, amounts, and remarks pertaining to the respective ones of the present transaction and past transactions (history). The image illustrated in FIG. 6 is image data pertaining to each transaction, the account title is an account title pertaining to each transaction, the amount is an amount extracted from the image data pertaining to each transaction, and the remark is a summary of a process pertaining to each transaction or the like. Note that a link 51 may be further displayed in the remark of the history display screen 50 to display a detailed process conducted in the past.

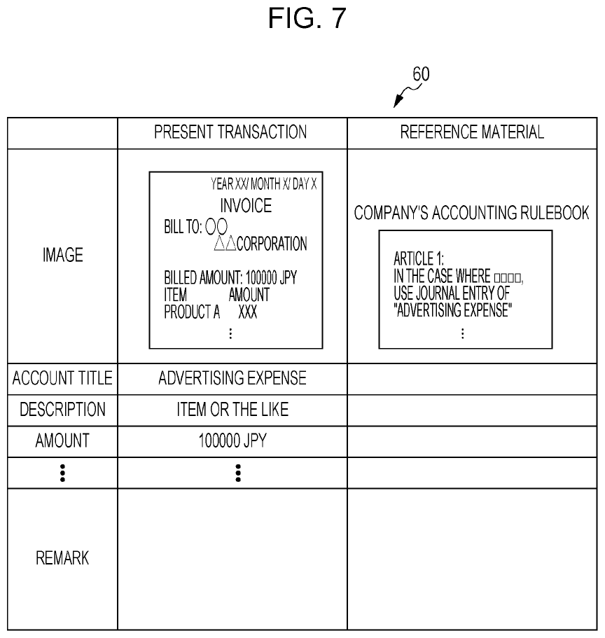

Furthermore, in the account title display screen 40 illustrated in FIG. 5, when the pressing down of a link 42 pertaining to a reference material of accounting rules or the like is detected, the presentation unit 26 displays a reference material display screen 60 illustrated in FIG. 7. The reference material display screen 60 displays the image data, the account title, the description, the amount, the remark, and the reference material obtained as the related information pertaining to the present transaction.

Furthermore, in the account title display screen 40 illustrated in FIG. 5, when related information is retrieved from the management indicators, the presentation unit 26 displays a presentation sentence stating that the presented account title can be selected and a button 43 for executing an instruction to request a confirmation regarding whether the present transaction is applicable to the presented account title.

Furthermore, the presentation unit 26 presents, as related information, a presentation sentence regarding a condition relating to the account title using the data structure 32 relating to conditions illustrated in FIG. 4. For example, when an account title that may achieve a tax saving is estimated, the presentation unit 26 displays a presentation sentence regarding a requirement to achieve a tax saving when this account title is selected in the account title display screen 40. When the account title “fixed assets” is selected and the one-time depreciation is conducted, and further when conditions of filing “blue return” and achieving “profit” are satisfied, the estimation unit 24 determines that “tax saving” of “X % of profit” is possible by reference to the data structure 32 relating to conditions. The search unit 25 obtains the requirement for achieving a tax saving by reference to the data structure 32 relating to conditions, and the presentation unit 26 generates a presentation sentence from the obtained conditions and displays the generated presentation sentence in the history display screen 50 as the related information.

Therefore, the related information has a plurality of modes depending on the attribute of the related information as “history 1” illustrated in FIG. 6 and “reference material” illustrated in FIG. 7, and the presentation unit 26 presents the related information in accordance with the attribute of the related information obtained by the search unit 25. Furthermore, as illustrated in FIG. 6 and FIG. 7, the presentation unit 26 allows to contrast pieces of information to be used for account title selection by displaying, side by side, the information relating to the present transaction and the related information relating to the reference material of the past transaction information (history), the accounting rules, or the like. Here, the information representing the attribute of related information such as “history 1”, “reference material”, or the like is an example of mode information. The attribute of related information is easily recognizable because the related information is displayed while displaying the mode information representing the attribute of the related information.

Note that the data structure 31 relating to account titles and the data structure 32 relating to conditions according to the present exemplary embodiment may be generated in advance by a user by setting pieces of information in such a manner as to be linked with each other or may be generated as a result of learning of past transaction information by the estimation unit 24. Furthermore, information pertaining to the data structure 31 relating to account titles and the data structure 32 relating to conditions may be added, modified, or changed by a user or may be added, modified, or changed as a result of learning by the estimation unit 24.

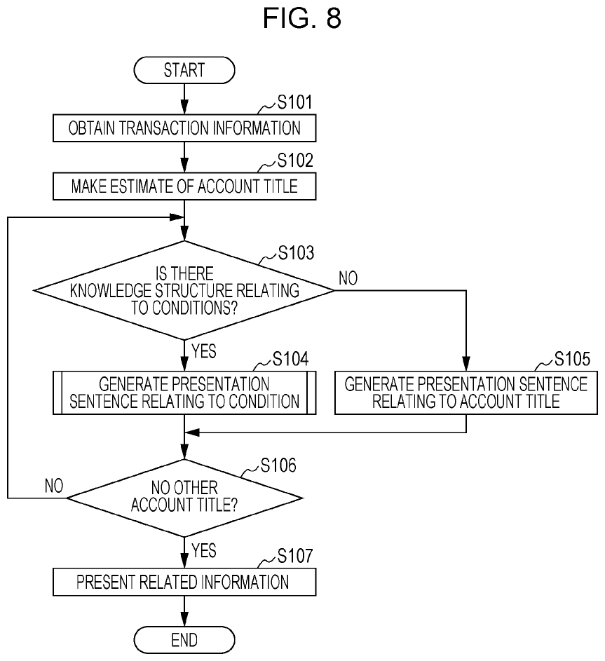

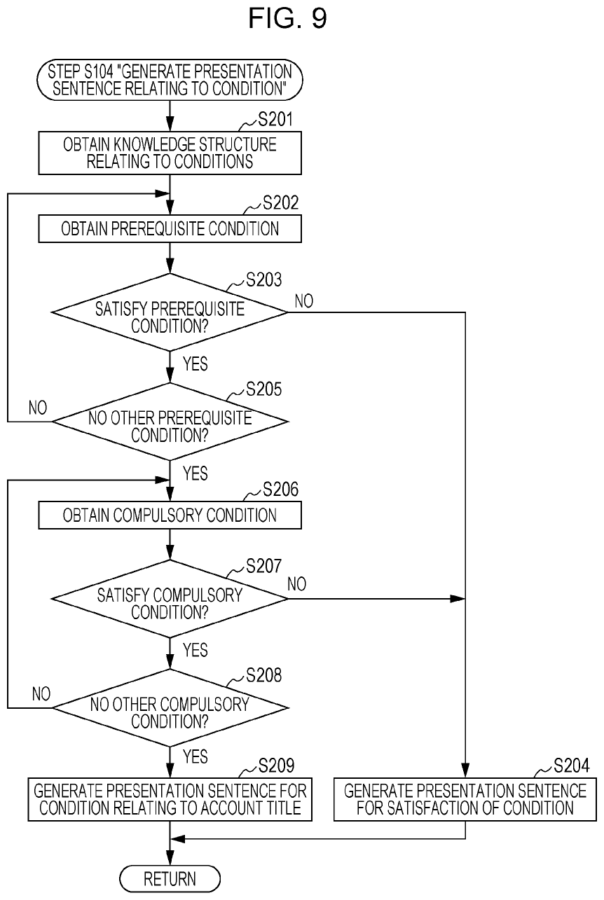

Next, referring to FIG. 8 and FIG. 9, operation of the information processing apparatus 10 according to the present exemplary embodiment is described. FIG. 8 is a flowchart illustrating an example of a process to present account titles and related information according to the present exemplary embodiment. An information processing program illustrated in FIG. 8 is executed when the CPU 11 reads out the information processing program from the ROM 12 or the storage 14 and runs the read-out information processing program. The information processing program illustrated in FIG. 8 is executed, for example, when an image is input by a user and further an instruction is input to present one or more account titles and related information thereof.

In step S101, the CPU 11 obtains transaction information from image data or the like input by a user.

In step S102, the CPU 11 makes an estimate of the account title using the transaction information.

In step S103, the CPU 11 determines whether or not there is a data structure 32 relating to conditions for the estimated account title. When there is a data structure 32 relating to conditions (step S103: YES), the CPU 11 proceeds to step S104. On the other hand, when there is no data structure 32 relating to conditions (step S103: NO), the CPU 11 proceeds to step S105.

In step S104, the CPU 11 executes a process to generate a presentation sentence relating to a condition as related information. Note that the process to generate related information relating to a condition is described in detail using FIG. 9, which will be described below.

In step S105, the CPU 11 searches past transaction information, reference materials, and a data structure 31 relating to the account title, which are stored, for information relating to the account title as the related information and generates a presentation sentence relating to the account title.

In step S106, the CPU 11 determines whether or not there is another estimated account title. When there is no other account title (step S106: YES), the CPU 11 proceeds to step S107. On the other hand, when there is another account title (step S106: NO), the CPU 11 obtains another account title and proceeds to step S103.

In step S107, the CPU 11 presents the generated presentation sentence as related information.

Next, referring to FIG. 9, a process to generate a presentation sentence relating to a condition of an account title is described. FIG. 9 is a flowchart illustrating an example of a process to generate a presentation sentence relating to a condition of an account title according to the present exemplary embodiment. A generation process program illustrated in FIG. 9 is executed when the CPU 11 reads out the generation process program from the ROM 12 or the storage 14 and runs the read-out generation process program. The generation process program illustrated in FIG. 9 is executed when an instruction to generate a presentation sentence relating to a condition of an account title is input.

In step S201, the CPU 11 obtains the data structure 32 relating to conditions for the estimated account title.

In step S202, the CPU 11 obtains a prerequisite condition from the data structure 32 relating to conditions.

In step S203, the CPU 11 derives information relating to the prerequisite condition from transaction information and determines whether or not the derived information satisfies the prerequisite condition. When the prerequisite condition is satisfied (step S203: YES), the CPU 11 proceeds to step S205. On the other hand, when the prerequisite condition is not satisfied (step S203: NO), the CPU 11 proceeds to step S204.

In step S204, the CPU 11 generates a presentation sentence for satisfaction of the condition. Here, the presentation sentence for satisfaction of a condition is a presentation sentence relating to transaction information that did not satisfy a prerequisite condition or a compulsory condition. For example, when the condition is not satisfied because the profit and loss is “loss” in the data structure 32 relating to conditions illustrated in FIG. 4, the following presentation sentence is generated: “Because a calculation result of predicted net profit of current year turns negative (loss), no tax saving effect is expected.”

In step S205, the CPU 11 determines whether or not there is another prerequisite condition in the data structure 32 relating to conditions. When there is no other prerequisite condition in the data structure 32 relating to conditions (step S205: YES), the CPU 11 proceeds to step S206. On the other hand, when there is another prerequisite condition in the data structure 32 relating to conditions (step S205: NO), the CPU 11 proceeds to step S202.

In step S206, the CPU 11 obtains a compulsory condition from the data structure 32 relating to conditions.

In step S207, the CPU 11 derives information relating to the compulsory condition from transaction information and determines whether or not the derived information satisfies the compulsory condition. When the compulsory condition is satisfied (step S207: YES), the CPU 11 proceeds to step S208. On the other hand, when the compulsory condition is not satisfied (step S207: NO), the CPU 11 proceeds to step S204.

In step S208, the CPU 11 determines whether or not there is another compulsory condition in the data structure 32 relating to conditions. When there is no other compulsory condition in the data structure 32 relating to conditions (step S208: YES), the CPU 11 proceeds to step S209. On the other hand, when there is another compulsory condition in the data structure 32 relating to conditions (step S208: NO), the CPU 11 proceeds to step S206 and obtains another compulsory condition.

In step S209, the CPU 11 generates a presentation sentence for the case where a condition is satisfied. Here, the presentation sentence for the case where a condition is satisfied is a presentation sentence relating to transaction information that satisfied requirements of a prerequisite condition and a compulsory condition in the data structure 32 relating to conditions. For example, when the prerequisite condition and the compulsory condition in the data structure 32 relating to conditions illustrated in FIG. 4 are satisfied, the presentation sentence “The blue return system allows one-time depreciation of the fixed assets” is generated. Furthermore, when a specific numerical value of profit or the like is derived, the presentation sentence “When making profit, the tax amount can be reduced by depreciation. Currently, the profit is XX.” is generated. Here, a derived numerical value is entered in “XX”.

As described above, the present exemplary embodiment may allow the account titles and the information for assessing the account titles to be presented.

Note that the present exemplary embodiment is described using the embodiment in which the account title is estimated by using the transaction information extracted from the image data. However, the exemplary embodiment is not limited thereto. The account title may alternatively be estimated from the type of a document by analyzing the type of a document from a layout of the document depicted in the image data. That is to say, information representing the layout of a document may be linked with the account title in the data structure relating to account titles according to the present exemplary embodiment, and the account title may be estimated from the information representing the layout of a document.

Furthermore, the data structure according to the present exemplary embodiment is described using the embodiment in which as information, words such as “buildings”, “repair expense”, and the like are linked with each other. However, the exemplary embodiment is not limited thereto. As the information, pieces of image data may be linked with each other, or contents described in reference materials such as accounting rules, the statute book, and the like and pages describing such contents may be linked with each other.

Although the present disclosure has been described using the exemplary embodiment described above, the present disclosure is not limited to the scope described in the exemplary embodiment described above. Various changes and improvements may be made to the exemplary embodiment without departing the scope of the present disclosure, and configurations obtained by making these changes and improvements are also included in the technical scope of the present disclosure.

In the exemplary embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to the one described in the embodiment above and may be changed.

Furthermore, the present exemplary embodiment is described using the embodiment in which the information processing program is installed in the storage 14. However, the exemplary embodiment is not limited thereto. The information processing program according to the present exemplary embodiment may alternatively be provided in the form of a computer readable storage medium storing the information processing program according to the present exemplary embodiment. For example, the information processing program according to the present disclosure may be provided in the form of an optical disc such as a compact disc (CD)-ROM, a digital versatile disc (DVD)-ROM, or the like, storing the information processing program according to the present disclosure. The information processing program according to the present disclosure may be provided in the form of a semiconductor memory such as a universal serial bus (USB) memory, a memory card, or the like, storing the information processing program according to the present disclosure. Alternatively, the information processing program according to the present exemplary embodiment may be obtained from an external apparatus via a communication channel connected to the communication I/F 17.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
present an account title relating to information obtained from a voucher together with related information relating to the account title.

2. The information processing apparatus according to claim 1, wherein the processor is configured to:
present a plurality of account titles; and
present related information of the plurality of account titles in such a manner as to be able to contrast pieces of the related information of respective account titles.

3. The information processing apparatus according to claim 1, wherein
the related information has a plurality of modes, and
the processor is configured to present the related information together with mode information representing a mode of the related information.

4. The information processing apparatus according to claim 2, wherein
the related information has a plurality of modes, and
the processor is configured to present the related information together with mode information representing a mode of the related information.

5. The information processing apparatus according to claim 1, wherein the processor is configured to present the account title relating to information obtained from a voucher using a data structure in which the information and the account title are linked with one another.

6. The information processing apparatus according to claim 2, wherein the processor is configured to present the account title relating to information obtained from a voucher using a data structure in which the information and the account title are linked with one another.

7. The information processing apparatus according to claim 3, wherein the processor is configured to present the account title relating to information obtained from a voucher using a data structure in which the information and the account title are linked with one another.

8. The information processing apparatus according to claim 4, wherein the processor is configured to present the account title relating to information obtained from a voucher using a data structure in which the information and the account title are linked with one another.

9. The information processing apparatus according to claim 5, wherein
the data structure includes a knowledge structure in which pieces of information are linked with one another in accordance with a predetermined rule in such a way that one piece of information is derived from another piece of information based on the predetermined rule, and
the processor is configured to present an account title linked with information derived from the information obtained from a voucher in the knowledge structure.

10. The information processing apparatus according to claim 6, wherein
the data structure includes a knowledge structure in which pieces of information are linked with one another in accordance with a predetermined rule in such a way that one piece of information is derived from another piece of information based on the predetermined rule, and
the processor is configured to present an account title linked with information derived from the information obtained from a voucher in the knowledge structure.

11. The information processing apparatus according to claim 7, wherein
the data structure includes a knowledge structure in which pieces of information are linked with one another in accordance with a predetermined rule in such a way that one piece of information is derived from another piece of information based on the predetermined rule, and
the processor is configured to present an account title linked with information derived from the information obtained from a voucher in the knowledge structure.

12. The information processing apparatus according to claim 8, wherein
the data structure includes a knowledge structure in which pieces of information are linked with one another in accordance with a predetermined rule in such a way that one piece of information is derived from another piece of information based on the predetermined rule, and
the processor is configured to present an account title linked with information derived from the information obtained from a voucher in the knowledge structure.

13. The information processing apparatus according to claim 1, wherein the processor is configured to present, as the related information, information relating to a requirement at time of accounting process using the account title being presented.

14. The information processing apparatus according to claim 2, wherein the processor is configured to present, as the related information, information relating to a requirement at time of accounting process using the account title being presented.

15. The information processing apparatus according to claim 3, wherein the processor is configured to present, as the related information, information relating to a requirement at time of accounting process using the account title being presented.

16. The information processing apparatus according to claim 4, wherein the processor is configured to present, as the related information, information relating to a requirement at time of accounting process using the account title being presented.

17. The information processing apparatus according to claim 5, wherein the processor is configured to present, as the related information, information relating to a requirement at time of accounting process using the account title being presented.

18. The information processing apparatus according to claim 13, wherein the processor is configured to present the related information with different contents when the requirement is satisfied and when the requirement is not satisfied.

19. An information processing method comprising:
presenting an account title relating to information obtained from a voucher together with related information relating to the account title.

20. A non-transitory computer readable medium storing a program causing a computer to execute a process, the process comprising:
presenting an account title relating to information obtained from a voucher together with related information relating to the account title.
